(19) United States
(12) Patent Application Publication
(10) Pub. No.: US 2020/0107624 A1
(43) Pub. Date: Apr. 9, 2020

(54) PAN FOR DEPILATORY WAX

(71) Applicant: David PORTILLO DE LA TORRE, Barcelona (ES)

(72) Inventor: David PORTILLO DE LA TORRE, Barcelona (ES)

(21) Appl. No.: 16/708,704

(22) Filed: Dec. 10, 2019

Related U.S. Application Data
(63) Continuation of application No. 15/542,824, filed on Jul. 11, 2017.

(30) Foreign Application Priority Data
Jan. 13, 2015 (ES) U201530025

(51) Int. Cl. A45D 26/00; A47J 27/00; A47J 36/02; B65D 25/28

(52) U.S. Cl. CPC A45D 26/0014; A47J 27/00; B65D 25/2805; A47J 36/02; A45D 26/00

(57) ABSTRACT

A pan for depilatory wax, consisting of a container (2) and a handle (3) made of a material suitable for withstanding direct contact with flames, incandescent resistance and glass ceramic surfaces that reach high temperatures, as well as for the flow therethrough of electromagnetic waves of a microwave oven without absorbing energy. The container (2) and the handle (3) can be made of aluminum, ceramic, tempered glass or Pyrex®-type glass. The handle (3) is fixed, collapsible or foldable on the container (2) and is coated with a layer (4) of insulating and protective material. The container is well suited for depilatory wax.

### RELATED APPLICATIONS

This application is a continuation of U.S. application Ser. No. 15/542,824 filed Jul. 11, 2017 as a U.S. National Phase of PCT Application Serial Number PCT/ES2016/070005 filed Jan. 11, 2016 that in turn claims priority benefit of Spanish Application Number 0201530025 filed Jan. 13, 2015; the contents of which are incorporated herein by reference.

### OBJECT OF THE INVENTION

The invention, as stated in the title of the present specification, relates to a pan for depilatory wax, which provides several advantages and innovative characteristics inherent to the particular configuration thereof, which are described in detail below and which amount to a novelty in the current state of the art.

The object of the present invention is specifically focused on a pan of the type that is intended to contain depilatory wax and can be heated in order to achieve the necessary degree of fluidity for the application thereof, and has the particular feature of being a container manufactured with a material that allows the use thereof with any electric, gas or glass ceramic stove, as well as with a microwave oven, in order to heat the aforementioned wax contained therein. Furthermore, the pan has a handle that is also made of a suitable material for use both on the stove and in a microwave oven and which is preferably coated with a protective layer of silicone or Bakelite.

### FIELD OF APPLICATION OF THE INVENTION

The field of application of the present invention falls within the sector of the industry, which manufactures household utensils, specifically focusing on the field of accessories for hot depilatory wax.

### BACKGROUND OF THE INVENTION

The technical problem of existing pans for hot depilatory wax is that they can either only be used on electric, gas or glass ceramic stoves, due to the fact that the material they are made of is steel or stainless steel and therefore resistant to high temperatures and to the heat of the flames or the heat in general of said type of stoves, or they can only be used in microwave ovens because the material of which they are made is a plastic that is only suitable for this type of ovens.

However, existing pans for hot depilatory wax on the market can not be used interchangeably in both types of heating systems, in other words, on the one hand on electric, gas or glass ceramic stoves and, on the other, in microwave ovens, given that, as is known, plastic materials normally used in microwave ovens do not withstand the high temperatures of a stove, and metal materials, such as stainless steel, are not suitable for use in microwave ovens.

It would therefore be desirable to have specific pans for said application of heating wax which can be used on different types of existing stoves, with the exception of induction stoves which require materials with different magnetic properties, and which, in addition, can be used in microwave ovens, the main objective of the present invention being to develop a pan incorporating said advantages.

On the other hand, it is also worth mentioning that the applicant has no knowledge of the existence of any other pan for heating depilatory wax or of a similar invention having the same technical, structural and constituent characteristics thereof.

### DESCRIPTION OF THE INVENTION

Thus, the pan for depilatory wax proposed by the invention constitutes a remarkable novelty within its field of application, the characterizing details that make it possible being conveniently established in the final claims, which accompany the present specification.

Specifically, the pan proposed by the invention conventionally comprises a container, normally circular, and, always having dimensions that are considerably reduced when compared to a pan for cooking food, to which a handle is attached in order to facilitate the handling thereof.

According to an essential characteristic of the invention, said container is manufactured with a material that is suitable for heating on an electric, gas or glass ceramic stove, and therefore, suitable for withstanding direct contact with flames, incandescent resistance and glass ceramic surfaces that reach high temperatures, at the same time being a material suitable for use in a microwave oven and, therefore, suitable for allowing the electromagnetic waves of said type of oven to pass through the same without absorbing energy. Thus, the wax contained in the container is heated without said container or apparatus being affected.

Preferably, said material, suitable for withstanding direct contact with flames, incandescent resistance and glass ceramic surfaces that reach high temperatures, and suitable for allowing electromagnetic waves or microwaves to pass through the same without absorbing energy, is aluminum, ceramic or glass, specifically tempered glass or Pyrex®-type glass.

Aluminum, contrary to what people used to think, especially with regard to current microwave ovens, is a material that, in spite of the fact that it is a metal, is suitable for use in said type of ovens.

In fact, some noteworthy characteristics of aluminum, and the use thereof in microwave ovens, are that it conducts heat more efficiently; it is versatile and lightweight, hygienic, more affordable than other materials and 100% recyclable. Moreover, it is also more effective than traditional materials.

Studies have shown that aluminum can be used in microwave ovens without any risk to the oven or the user, as long as the usual instructions for the use of these devices are complied with.

With regard to ceramic materials, materials such as stoneware and ceramics are very resistant because they can perfectly withstand high temperatures, do not scratch, retain heat extremely well and, since they are not metallic, they are perfectly suitable for use in microwave ovens.

On the other hand, tempered glass, borosilicate (Pyrex®) or colorless glass are types of glass that are resistant to thermal shocks, making them perfectly suitable for use in both systems, that is, on a stove and in a microwave oven.

In keeping with the characteristics of the pan of the invention, it is also worth noting that the handle, which can even be collapsible or foldable, is also made of a material suitable for withstanding direct contact with flames, incandescent resistance and glass ceramic surfaces that reach high temperatures, as well as the electromagnetic waves of microwave ovens that pass through the same without absorbing energy, this material preferably being the same material that the container is made of.

Furthermore, in a preferred embodiment of the invention, the handle, which can even be collapsible or foldable, is coated with an insulating and protective layer, preferably silicone or Bakelite, so that the user can grasp and handle the pan without burning themselves when the pan is hot.

The described pan for heating depilatory wax therefore consists of an innovative structure with structural and constituent characteristics heretofore unknown for its intended purpose, reasons which, together with its practical usefulness, provide it with sufficient grounds for obtaining the requested exclusivity privilege.

### DESCRIPTION OF THE DRAWINGS

To complement the present description, and for the purpose of helping to make the characteristics of the invention more readily understandable, the present specification is accompanied by one drawing, constituting an integral part of the same, which by way of illustration and not limitation represents the following:

FIGURE number 1, the only FIGURE, shows a perspective view of an exemplary embodiment of the pan, object of the invention, with the handle provided with an insulating and protective layer, preferably of silicone or Bakelite.

### PREFERRED EMBODIMENT OF THE INVENTION

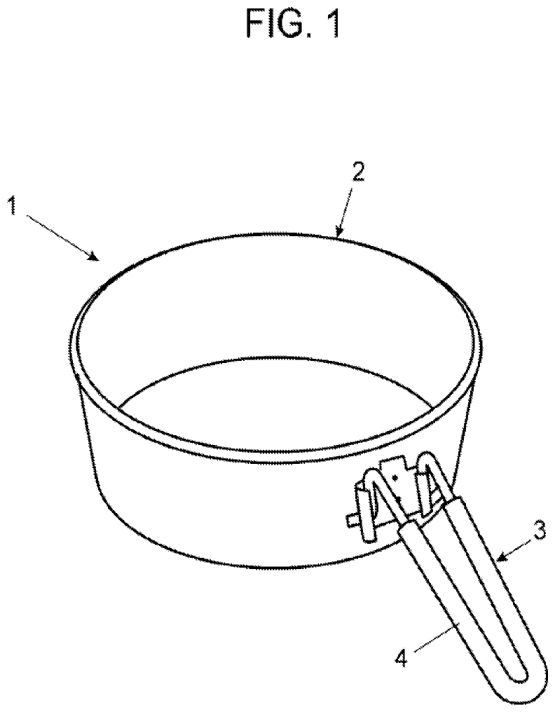

In light of said single FIG. 1, and according to the adopted numbering, a preferred but non-limiting embodiment of the pan for depilatory wax of the invention can be seen, which comprises the parts and elements indicated and described in detail below.

Thus, as seen in said FIG. 1, the pan (1) in question, applicable for heating depilatory wax either on as electric, gas, or glass ceramic stove, or in a microwave oven, is made up of container (2) with a fixed handle (3), optionally collapsible or foldable, said container (2) being made of a material suitable for use in direct contact with flames, incandescent resistance and glass ceramic surfaces that reach high temperatures, as well as for allowing electromagnetic waves of a microwave oven to pass through the same without absorbing energy.

Preferably, said material with which the container (2) is made is aluminum, ceramic or glass, specifically tempered glass or Pyrex®-type glass.

In turn, the handle (3), fixed, collapsible or foldable, is also made of a material suitable for withstanding direct contact with flames, incandescent resistance and glass ceramic surfaces that reach high temperatures, as well as the electromagnetic waves of microwave ovens that pass through the same without absorbing energy, preferably being the same material that the container (2) is made of.

Additionally, the handle (3) is coated with a layer (4) of insulating and protective material, preferably silicone or Bakelite.

Having sufficiently described the nature of the present invention, as well as the ways of implementing it, it is not considered necessary to extend its explanation for any expert in the state of the art to understand its scope and the advantages that derive from it, specifying that, within its essence, it can be carried out in other embodiments that differ in detail from the one provided by way of example, and which are also covered by the requested protection, provided that they do not alter, change or modify its fundamental principle.

1. A process of heating depilatory wax comprising:
heating the depilatory wax in a pan comprising a container (2) made of one of aluminum, ceramic, tempered glass or Pyrex® and a handle (3), where said container (2) and said handle (3) are made of a material suitable for direct contact with flames, incandescent resistance, and glass ceramic surfaces, as well as for allowing electromagnetic waves of a microwave oven to pass through said container (2) and said handle (3) without absorbing energy the heating occurring on one of an electric, a gas stove, or a glass ceramic stove, or in a microwave oven.

2. The process according to claim 1, characterized in that the handle (3) is made of the same material as the container (2).

3. The process according to claim 1, characterized in that the handle (3) is fixed on the container (2).

4. The process according to claim 1, characterized in that the handle (3) is coated with a layer (4) of insulating and protective material.

5. The process of claim 7 wherein said layer is silicone or Bakelite.

6. The process according to claim 1, characterized in that the handle (3) is collapsible or foldable on the container (2).
